(19) United States
(12) Patent Application Publication
(10) Pub. No.: US 2013/0040034 A1
(43) Pub. Date: Feb. 14, 2013

(54) LOW-FAT CAKE AND METHOD OF MAKING THE SAME

(71) Applicants: Maki MATSUBARA, Itami-shi (JP); Junichi URAKAMI, Itami-shi (JP)

(72) Inventors: Maki MATSUBARA, Itami-shi (JP); Junichi URAKAMI, Itami-shi (JP)

(73) Assignee: MATSUTANI CHEMICAL INDUSTRY CO., LTD., Itami-shi (JP)

(21) Appl. No.: 13/569,693

(22) Filed: Aug. 8, 2012

(30) Foreign Application Priority Data
Aug. 9, 2011 (JP) 2011-174111

(51) Int. Cl. A21D 13/08; A23L 1/308

(52) U.S. Cl. 426/559; 426/549

(57) ABSTRACT

The purpose of the present invention is to provide a low-fat cake having improved quality, wherein the flavor, full-bodied taste (richness), softness, swellability, and baked color which are derived from of fats and oils are not at all impaired even if the amount of the fats and oils is reduced, and a method of making the same.

The above-described problem is solved by the method of making a cake using wheat flour and fats and oils as raw materials, characterized by using 15 to 90 parts by mass of the fats and oils based on 100 parts by mass of the wheat flour and adding 40 to 10 parts by mass of water-soluble dietary fiber such that the total amount of said fats and oils and the water-soluble dietary fiber is not less than 37 parts by mass and not more than 100 parts by mass.

### TECHNICAL FIELD

The present invention is intended to reduce the caloric content of cakes such as a butter cake and a muffin in which a relatively large amount of fats and oils is used and relates to a method by which deterioration of taste that occurs when the amount of fats and oils is reduced is avoided and a cake obtained by the method.

### BACKGROUND ART

In recent years, with increasing health consciousness, a number of various health-conscious foods in which the amount of food ingredients itself is reduced in order to display, for example, “low-salt”, “sugar-free”, “low-fat”, “low-calorie”, and the like or in which food materials having some functionality are added have been on the market.

Among them, a “low-fat” or “low-calorie” food can be readily achieved if the amount of, for example, fats and oils or sugar is reduced, but there exists a hardly solvable problem in that the flavor and full-bodied taste derived from fats and oils or sugar will be lost and it is extremely difficult to recover the impaired balance of taste quality.

Further, for cakes, the addition effect of fats and oils is said to be particularly essential because it does not only provide a flavor and a full-bodied taste but also significantly affects the shape, appearance, and texture.

Some methods for solving various problems of deterioration of flavor, full-bodied taste (richness), softness, swelling, baked color, and the like, which can occur in such a cake with a reduced amount of fats and oils, have ever been studied. However, although the method of making a birthday cake in which the lost massiveness due to the reduction of fats and oils is offset by using oligosaccharides has been proposed, for example (Patent Document 1), the softness that a cake should naturally possess cannot be obtained only by substituting oligosaccharides for fats and oils, and the cake remains in a scone- or cookie-like and rough or dry state. Further, although the method in which the amount of fats and oils in cookie-like baked sweets is reduced and water-soluble dietary fiber is added has been reported (Patent Document 2), the method has a problem of improving the crisp texture that is impaired when the amount of fats and oils in cookie-like baked sweets is reduced.

### CITATION LIST

### Patent Literature

[Patent Document 1] JP 2010-115184 A
[Patent Document 2] JP 2006-325471 A

### SUMMARY OF INVENTION

### Technical Problem

An object of the present invention is to provide a low-fat cake having improved quality, wherein the flavor, full-bodied taste (richness), softness, swellability, and baked color which are derived from of fats and oils are not at all impaired even if the amount of the fats and oils is reduced, and a method of making the same.

### Solution to Problem

The present inventors intensively studied in view of the above-mentioned problems to discover that the substitution of water-soluble dietary fiber for a portion of fats and oils that should be used in a cake solves all the above-described problems and provides a low-fat cake having improved quality.

Thus the present invention provides the following.

<1> A method of making a cake using wheat flour and fats and oils as raw materials, characterized by using 15 to 90 parts by mass of the fats and oils based on 100 parts by mass of the wheat flour and adding 40 to 10 parts by mass of water-soluble dietary fiber such that the total amount of the fats and oils and the water-soluble dietary fiber is not less than 37 parts by mass and not more than 100 parts by mass.
<2> A method of making a cake using wheat flour and fats and oils as raw materials, comprising determining an amount of flour and fats and oils for the desired cake, and substituting water-soluble dietary fiber for at least a portion of the determined amount of fats and oils, wherein the amount of the fats and oils and the water-soluble dietary fiber after substitution is 15 to 90 parts by mass and 40 to 10 parts by mass based on 100 parts by mass of the wheat flour, respectively, and further the total amount of the fats and oils and the water-soluble dietary fiber is not less than 37 parts by mass and not more than 100 parts by mass.
<3> The method of making a cake according to <1> or <2> above, wherein the water-soluble dietary fiber is at least one selected from the group consisting of indigestible dextrin, polydextrose, and inulin.
<4> The method of making a cake according to any one of <1> to <3> above, wherein the cake is selected from the group consisting of a sponge cake, butter cake, muffin, cupcake, financier, madeleine, pound cake, and waffle.
<5> A cake made by the method according to any one of <1> to <4> above.

### Advantageous Effects of Invention

According to the present invention, the calories due to fats and oils can be reduced, and besides a cake having a good baked color can be obtained without impairing the flavor, full-bodied taste (richness), and softness natural to cakes.

### DESCRIPTION OF EMBODIMENTS

“A cake(s)” herein refers to those obtained by compounding mainly wheat flour, fats and oils, sugar, egg wash, and the like to make a batter and pouring the batter, for example, into a mold for baking. Specific examples include a muffin, cupcake, financier, madeleine, cake doughnut, butter cake, pound cake, sponge cake, bouchée, waffle, pancake, castella, and pancake-like patties of Dorayaki (Dorayaki is a Japanese-style sweet having two round pancake-like patties with bean jam sandwiched between thereof). The making method of the present invention is characterized by substituting water-soluble dietary fiber for fats and oils and therefore is particularly suitable for making a butter cake, muffin, cupcake, financier, madeleine, pound cake, and waffle in which fats and oils are used in large amounts.

From the standpoint of workability, storage stability, or consumer preference, in addition to such main ingredients, various auxiliary ingredients such as milk, fresh cream, emulsifier, baking powder, perfume, coloring matter, starch (including modified starch), starch syrup, oligosaccharide, dextrin, artificial sweetener, liqueur, and various topping agents can be used as required, and pregelatinized starch, natural gum, and the like can also be used for the purpose of adjusting batter viscosity or dispersing ingredients such as raisins.

“Water-soluble dietary fiber” herein refers to indigestible saccharides that contain dietary fiber in an amount of 50% by mass or more, as measured according to AOAC 2001. 03, dissolve in 100 ml of water at 20° C. by 20 g or more, and exhibit a viscosity of less than 20 mPa-s when dissolved into a 5% by mass aqueous solution at 20° C.

Specific examples of the water-soluble dietary fiber include, for example, indigestible dextrin (for example, the trade name “Pinefiber (registered trademark)” or “Fibersol-2” available from Matsutani Chemical Industry Co., Ltd. and the trade name “PROMITOR™ Soluble Corn Fiber” available from Tate & Lyle), polydextrose (for example, the trade name “Litesse” available from Danisco Cultor), branched maltodextrin (for example, the trade name “NUTRIOSE” available from ROQUETTE), and inulin. In addition to these, any water-soluble dietary fiber (indigestible saccharides) that satisfies the above-described conditions of low viscosity and water solubility may be used, and the form thereof may be powder or liquid.

In the present invention, the average molecular weight of water-soluble dietary fiber is preferably 500 to 5,000, more preferably 800 to 2,500, and the most effective and preferred water-soluble dietary fiber used in the present invention is indigestible dextrin.

Indigestible dextrin, which is obtained by adding small amounts of hydrochloric acid to starch and heating the resulting mixture before treatment with enzyme, refers to dextrin containing preferably 85 to 95% by mass of indigestible components and also encompasses reductants thereof produced by hydrogenation. According to the energy conversion factor of dietary fiber described in Shokushinhatsu No. 0217001 and No. 0217002, the energy value of indigestible dextrin is 1 kcal/g. The average molecular weight of indigestible dextrin is generally in the range of 1,000 to 2,500.

Indigestible dextrin, as mentioned above, is generally produced by adding hydrochloric acid and heating the resulting mixture before treatment with enzyme, but, in the present invention, may be indigestible dextrin obtained by preparation using any method.

The fats and oils used in the present invention are not particularly limited as long as they are edible fats and oils, examples of which include, for example, butter, margarine, shortening, lard, vegetable oil, and further composite fats and oils commonly called “compound”, and the form thereof may be any of liquid, powder, or solid.

In the present invention, wheat flour does not necessarily mean single wheat flour. In other words, wheat flour is not particularly limited as long as it is a flour that can be generally used in sweets and also encompasses wheat flours containing flours in a broad sense such as rice flour, rye flour, barley flour, tapioca flour, corn flour, potato flour, and soybean flour in any amount.

In general, gluten formation in the process of adding water to wheat flour and kneading is important for breads, but for cakes, glutinousness due to gluten formation is not preferred because it impairs the softness typical of a cake, and therefore soft wheat flour of low protein content or the like is often selected. However, wheat flour of relatively high protein content such as hard wheat flour or semi-hard wheat flour (or mixture of hard wheat flour and soft wheat flour) may be used because the above-mentioned water-soluble dietary fiber, particularly indigestible dextrin, prevents gluten formation by deprivation of water that is essential for the formation.

In the present invention, a cake in which 15 to 90 parts by mass of fats and oils based on 100 parts by mass of wheat flour in raw materials is used, wherein the texture and taste quality are well maintained by appropriately adding 40 to 10 parts by mass of water-soluble dietary fiber such that the total amount of the fats and oils and the dietary fiber is not less than, 37 and not more than 100 parts by mass, can be obtained.

In the present invention, 15 to 90 parts by mass of fats and oils based on 100 parts by mass of wheat flour is used.

In the present invention, by using water-soluble dietary fiber, even if the amount of fats and oils, which are generally used in a cake, is reduced, a cake can be made without impairing the flavor, full-bodied taste (richness), and softness that a cake in which a normal amount of fats and oils is used naturally has (that is derived from fats and oils). Therefore, the cake made by the present invention are those which are made originally by addition of about 50 to 150 parts by mass of fats and oils based on 100 parts by mass of wheat flour if water-soluble dietary fiber is not used.

In the present invention, 15 to 90 parts by mass, preferably 15 to 80 parts by mass, more preferably 15 to 70 parts by mass, and most preferably 17 to 50 parts by mass of fats and oils based on 100 parts by mass of wheat flour is used. With such an amount of fats and oils, the same degree of flavor, full-bodied taste (richness), and softness of a cake as in the case where a conventional amount of fats and oils is used are not impaired.

The water-soluble dietary fiber is added in an amount of 40 to 10 parts by mass such that the total amount of the fats and oils and the water-soluble dietary fiber is not less than 37 parts by mass and not more than 100 parts by mass. More preferably, it is added in an amount of 40 to 10 pails by mass such that the total amount of the fats and oils and the water-soluble dietary fiber is not less than 46 parts by mass and not more than 80 parts by mass. More preferably, the water-soluble dietary fiber is added in an amount of 10 to 30 parts by mass within the above-described range.

Further, instead of reducing fats and oils by 10 parts by mass, by adding water-soluble dietary fiber in an amount of 2.5 to 23 parts by mass such that the total amount is not more than 40 parts by mass, based on 100 parts by mass of raw wheat flour of the cake in which fats and oils are used, a good low-fat cake that improves in all of the flavor, full-bodied taste, softness, and baked color which will be lost by reduction of fats and oils can be obtained. When the amount of the water-soluble dietary fiber is less than 2.5 parts by mass based on 10 parts by mass of the fats and oils to be reduced, the ill effects (increased rough texture and dry texture, and impaired full-bodied taste and flavor) caused by reducing the fats and oils cannot be prevented, and when more than 23 parts by mass, problems arise in that sticky texture emerges, and swelling becomes worse.

More preferably, instead of reducing fats and oils by 10 parts by mass, by adding water-soluble dietary fiber in an amount of 5 to 18 parts by mass such that the total amount is not more than 40 parts by mass, based on 100 parts by mass of raw wheat flour of the cake in which fats and oils are used, a good low-fat cake that improves more than the cake made without reducing fats and oils in all of the flavor, full-bodied taste, softness, and baked color which will be lost by the reduction can be obtained.

Examples of preferred aspects of the present invention include a method of making a cake having less fat than before by the following steps.

1. The formula of a cake having a flavor, full-bodied taste, softness, and baked color of interest without using water-soluble dietary fiber is determined.
2. In the formula determined in the above step 1, the fats and oils in the amount calculated according to the caloric content to be reduced are substituted with 3 to 23 parts by mass, more preferably 5 to 18 parts by mass of water-soluble dietary fiber based on 10 parts by mass of the fats and oils reduced (the parts by mass is an amount based on 100 parts by mass of the wheat flour used). The substitution is performed with such an amount of the water-soluble dietary fiber that the total amount is not more than 40 parts by mass, preferably in the range of 10 to 40 parts by mass.
3. A low-fat cake having less fat than before and a flavor, full-bodied taste, softness, baked color, and the like of interest are made by making a cake according to the formula determined in the above step 2.

The low-fat cake made by utilizing the present invention is a cake that has not only a reduced calorie but also the flavor, full-bodied taste (richness), softness, and preferred baked color natural to cakes. In addition, it is also expected that physiological effects such as suppression of the increase in blood glucose, intestinal function-regulating effect, and improved lipid metabolism will be provided because water-soluble dietary fiber is added.

The present invention will now be described specifically by way of Experiments and Examples, but the present invention is not limited thereto.

### Experiment 1

### Effects of the Ratio of Fat and Oil Content to Water-Soluble Dietary Fiber Content on a Cake

An example of the experiments that investigated to what degree the fat and oil that should be used in cake dough can be substituted with water-soluble dietary fiber and the results is shown. In this experiment, indigestible dextrin (the trade name “Fibersol-2” available from Matsutani Chemical Industry Co., Ltd.) (average molecular weight: about 2000) is used as water-soluble dietary fiber.

Thirty types of “muffins with reduced fats and oils” were made by sequentially reducing the fats and oils (corresponding to ZENOA and PANTHEON SELECT M in the formulation table) and, at the same time, sequentially increasing the amount of dietary fiber in the basic formulation of muffin shown in Table 1. The making process will be described below Table 1.

Each muffin obtained was comprehensively evaluated for flavor, full-bodied taste (richness), softness, and baked color (the number of tester: 10) to give the results shown in Table 2.

The formulation in Table 1 is very general as a formulation of muffin.

TABLE 1
Basic formulation of muffin (the amount of water-soluble
dietary fiber is described separately in Table 2)

| Ingredients | Content (parts by mass) |
|---|---|
| Whole egg | 100 |
| High-fructose corn syrup | 20 |
| White superior soft sugar | 60 |
| Salt | 0.5 |
| Vanilla essence | 0.4 |
| Soft wheat flour | 100 |
| MATSUNORIN FA102*¹ | 5 |
| Non-fat dry milk | 5 |
| Aka Ace Baking Powder*² | 3 |
| ZENOA*³ | 30 |
| PANTHEON SELECT M*⁴ | 40 |
| Total | 363.9 |

*¹Pregelatinized cross-linked starch (waxy corn) available from Matsutani Chemical Industry Co., Ltd.
*²Baking powder available from OKUNO CHEMICAL INDUSTRIES CO., LTD.
*³Edible processed vegetable fat and oil available from TSUKISHIMA FOODS INDUSTRY CO., LTD.
*⁴Unsalted compound margarine available from MIYOSHI OIL & FAT CO., LTD.

### (Making Process)

(1) Whole eggs and high-fructose corn syrup were mixed and stirred.
(2) To the mixture of (1), white superior soft sugar, water-soluble dietary fiber, salt, and vanilla essence were added and mixed.
(3) Powders (soft wheat flour, MATSUNORIN FA102, non-fat dry milk, and baking powder) that had been well mixed and sieved were added to the mixture of (2) and mixed.
(4) To the mixture of (3), vegetable fat and oil and melted unsalted compound margarine were added and mixed.
(5) Into muffin cups, 45 g of dough were aliquoted, and baked at 180° C. from above and 170° C. from below for 16 minutes,

TABLE 2
Evaluation results

| Fat *¹ | Amount of water-soluble dietary fiber based on 100 parts by mass of wheat flour (parts by mass) | | | | | |
|---|---|---|---|---|---|---|
| (parts by mass) | 0 | 10 | 20 | 30 | 40 | 50 |
| 70 | Good | Good | Very good | Fair | Poor | Poor |
| | Control | No significant | Good | Slightly | Poor shape | Turned into a |
| | | change | particularly | brittle | retention | starch |
| | | | in melting in | | | syrup-like |
| | | | the mouth | | | form |
| 52.5 | Fair | Good | Very good | Good | Fair | Poor |
| | Dried out | Improved | Good | Good melting | Slightly | Sticky |
| | | | particularly | in the mouth | brittle | |
| | | | in melting in | | | |
| | | | the mouth | | | |
| 35 | Poor | Fair | Very good | Very good | Fair | Poor |
| | Dried out | Slightly | All good | All good | Bulk slightly | Sticky |
| | | improved | | | reduced | |
| 17.5 | Poor | Poor | Fair | Very good | Fair | Poor |
| | Considerably | Dried out | Slightly | All good | Bulk slightly | Sticky |
| | hardened | | improved | | reduced | |
| 0 | Poor | Poor | Poor | Poor | Poor | Poor |
| | Considerably | Considerably | Dried out | Dried out | Sticky | Sticky |
| | hardened | hardened | | | | |

*¹ Amount of fat: Amount of fats and oils based on 100 parts by mass of wheat flour (parts by mass)
Very good: Flavor, full-bodied taste, softness, and baked color are all very good.
Good: Flavor, full-bodied taste, softness, and baked color are all good.
Fair: Bulk reduction, stickiness, brittleness, and the like are slightly observed, but substantially good.
Poor: Flavor, full-bodied taste, softness, baked color, and the like are almost all poor.

First, adding 10 to 30 parts by mass of water-soluble dietary fiber to the basic formulation of Table 1 (using 100 parts by mass of wheat flour) caused no significant problem, and melting in the mouth was particularly good when 20 parts by mass was added.

Next, reducing 17.5 to 35 parts by mass of fats and oils from the basic formulation of Table 1 (formulating 52.5 to 35 parts by mass of fats and oils based on 100 parts by mass of wheat flour) caused hardening and deterioration, for example, of flavor, but adding 10 to 40 parts by mass of water-soluble dietary fiber improved the texture and flavor.

Further, reducing 52.5 parts by mass of fats and oils from the basic formulation of Table 1 (formulating 17.5 parts by mass of fats and oils based on 100 parts by mass of wheat flour) caused further hardening and considerable deterioration, for example, of flavor, but adding 20 to 40 parts by mass of water-soluble dietary fiber improved the texture and flavor.

In the case where no fat or oil was added (70 parts by mass of fats and oils that should be formulated based on 100 parts by mass of wheat flour was not added at all), flavor, full-bodied taste, softness, and baked color were all poor. No improvement was observed even when water-soluble dietary fiber was added, and besides ill effects such as stickiness were observed with increasing amount of the water-soluble dietary fiber.

It was found from the above that when the amount of fats and oils is 17.5 to 70 parts by mass based on 100 parts by mass of wheat flour in raw materials, a low-fat cake that is good in all of the flavor, full-bodied taste, softness, and baked color can be obtained by appropriately adding 40 to 10 parts by mass of water-soluble dietary fiber within such a range that the total amount of the fats and oils and the dietary fiber that is not less than 37 and not more than 100 parts by mass.

Further, in the range of the conditions above, by adding water-soluble dietary fiber in an amount of 2.5 to 23 parts by mass instead of reducing fats and oils by 10 parts by mass, a good low-fat cake that improved in all of the flavor, full-bodied taste, softness, and baked color which would be lost by reduction of fats and oils was obtained.

In the formulation of Table 1, when reducing ZENOA and PANTHEON SELECT M corresponding to fats and oils, the two were always reduced at the same rate (for example, “reducing fats and oils by 50%” means reducing ZENOA and PANTHEON SELECT M in Table 1 by 15 parts by mass and by 20 parts by mass, respectively.).

### Experiment 2

### Effects of Dextrin or Water-Soluble Dietary Fiber on a Cake

In Experiment 1, the fat and oil substitution effect that the water-soluble dietary fiber had was most evident in the formulation ratio of 17.5 parts by mass of fats and oils to 30 parts by mass of water-soluble dietary fiber based on 100 parts by mass of wheat flour, and, accordingly, the fat and oil substitution effect was evaluated when the total amount of fat and oil was reduced from 70 parts by mass to 17.5 parts by mass and 30 parts by mass of various water-soluble dietary fibers were added in the muffin basic formulation of Table 1.

As water-soluble dietary fiber, indigestible dextrin A (the trade name “Fibersol-2” available from Matsutani Chemical Industry Co., Ltd., average molecular weight: about 2000), indigestible dextrin B (the trade name “PROMITOR™ Soluble Corn Fiber 85” available from Tate & Lyle, average molecular weight: about 1000), branched maltodextrin (the trade name “NUTRIOSE FB10” available from ROQUETTE, average molecular weight: about 1600), polydextrose (the trade name “Litesse II” available from Danisco Cultor, average molecular weight: about 2000), and inulin (the trade name Raftiline HP available from Dai-Nippon Meiji Sugar Co., Ltd., average molecular weight: about 1500) were used, and as a control, common dextrin (the trade name “Pine-Dex #2”, DE10, available from Matsutani Chemical Industry Co., Ltd., average molecular weight: about 1700) was used.

The molecular weight of the indigestible dextrin A is a number average molecular weight measured using high-performance liquid chromatography, and known molecular weight of pullulan standards (Shodex Standard P-82 available from SHOWA DENKO K.K.), maltotriose, and glucose.

### (Evaluation Method)

The taste (flavor, full-bodied taste), texture (softness, melting in the mouth), and appearance (baked color, brightness, shape) of the muffins made by the method described above was judged by performing a panel test by 10 panelists (composed of 4 males and 6 females).

Comparing to the control (muffin with reduced fats and oils but no addition of dextrin or water-soluble dietary fiber), each of the taste, texture, and appearance was evaluated on a 3-point scale: “No change” (equivalent to the control); “Slightly improved (the fat and oil substitution effect is small)”; and “Significantly improved (the fat and oil substitution effect is large)”, and the number of the panelists who performed each evaluation is shown in Tables 3 to 5 below.

### (Evaluation Results)

TABLE 3

| | Taste (flavor, full-bodied taste) | | |
|---|---|---|---|
| Water-soluble dietary fiber or | | Slightly | Significantly |
| dextrin added (product name) | No change | improved | improved |
| Fibersol-2 | 0 | 1 | 9 |
| PROMITOR | 0 | 2 | 8 |
| NUTRIOSE FB | 1 | 4 | 5 |
| Litesse II | 1 | 4 | 5 |
| Raftiline HP | 1 | 7 | 2 |
| Pine-Dex #2 | 4 | 5 | 1 |

TABLE 4

| | Texture (softness, melting in the mouth) | | |
|---|---|---|---|
| Water-soluble dietary fiber or | | Slightly | Significantly |
| dextrin added (product name) | No change | improved | improved |
| Fibersol-2 | 0 | 1 | 9 |
| PROMITOR | 0 | 1 | 9 |
| NUTRIOSE FB | 0 | 2 | 8 |
| Litesse II | 0 | 4 | 6 |
| Raftiline HP | 1 | 7 | 2 |
| Pine-Dex #2 | 4 | 5 | 1 |

TABLE 5

| | Appearance | | |
|---|---|---|---|
| | (baked color, brightness, shape) | | |
| Water-soluble dietary fiber or | | Slightly | Significantly |
| dextrin added (product name) | No change | improved | improved |
| Fibersol-2 | 0 | 4 | 6 |
| PROMITOR | 0 | 5 | 5 |
| NUTRIOSE FB | 1 | 6 | 3 |
| Litesse II | 1 | 7 | 2 |
| Raftiline HP | 3 | 6 | 1 |
| Pine-Dex #2 | 5 | 5 | 0 |

As is evident from the above experimental results, Pine-Dex #2, a common dextrin, had a generally small effect of improving the full-bodied taste, softness, baked color, and the like that were lost through fat reduction, whereas Fibersol-2, NUTRIOSE FB, Litesse II, and Raftiline HP, which are water-soluble dietary fibers, apparently had an improvement effect despite some difference in the magnitude of the effect. Among them, indigestible dextrins, Fibersol-2 and PROMITOR™ Soluble Corn Fiber 85 particularly had a large fat substitution effect.

### Example 1

### Butter Cake

A butter cake was made according to the formulation and process below. No significant deterioration in quality (such as taste quality, texture, shape, and baked color) was observed despite the reduction of fat and oil, and the finish was by no means inferior to the control despite being low-calorie.

In other words, it was found that, even in the butter cake in which 90 parts by mass of fats and oils based on 100 parts by mass of wheat flour is used, the flavor, full-bodied taste, softness, baked color, and the like that are lost through reduction in the amount of fat and oil are improved by adding water-soluble dietary fiber within the above condition range, as is similar to the muffins of the above Experiments.

TABLE 6
Butter cake formulation

| | Formulation (parts by mass) | | | |
|---|---|---|---|---|
| | | Example | Example | Example |
| Ingredients | Control | 1-1 | 1-2 | 1-3 |
| PANTHEON SELECT M*¹ | 75 | 37.5 | 37.5 | 18.8 |
| Shortening | 15 | 7.5 | 7.5 | 3.8 |
| Soft wheat flour | 100 | 100 | 100 | 100 |
| Fibersol-2 | — | 20 | 40 | 20 |
| Aka Ace Baking Powder*² | 1.5 | 1.5 | 1.5 | 1.5 |
| White superior soft sugar | 90 | 90 | 90 | 90 |
| Salt | 5 | 5 | 5 | 5 |
| Whole egg | 3 | 3 | 3 | 3 |
| Milk | 2 | 2 | 2 | 2 |
| Brandy | 3 | 3 | 3 | 3 |
| Rum | 2 | 2 | 2 | 2 |
| Total | 296.5 | 271.5 | 291.5 | 249.1 |

*¹Unsalted compound margarine available from MIYOSHI OIL & FAT CO., LTD.
*²Baking powder available from OKUNO CHEMICAL INDUSTRIES CO., LTD.

### (Making Process)

(1) Fats and oils (unsalted compound margarine, shortening) and sieved powders (soft wheat flour, baking powder, salts) were mixed and stirred.
(2) To the mixture of step (1), white superior soft sugar and Fibersol-2 were added and stirred.
(3) To the mixture of step (2), whole egg and milk were added and mixed.
(4) To the mixture of step (3), brandy and rum were added and mixed.
(5) Into pound-cake molds, 300 g of dough were aliquoted, and baked at 170° C. from above and below for 35 minutes.

What is claimed is:

1. A method of making a cake using wheat flour and fats and oils as raw materials, comprising adding 15 to 90 parts by mass of the fats and oils based on 100 parts by mass of the wheat flour and adding 40 to 10 parts by mass of water-soluble dietary fiber such that the total amount of said fats and oils and the water-soluble dietary fiber is not less than 37 parts by mass and not more than 100 parts by mass.

2. A method of making a cake using wheat flour and fats and oils as raw materials, comprising determining an amount of flour and fats and oils for a desired cake, and substituting water-soluble dietary fiber for at least a portion of the determined amount of fats and oils, wherein the amount of the fats and oils and the water-soluble dietary fiber after substitution is 15 to 90 parts by mass and 40 to 10 parts by mass based on 100 parts by mass of the wheat flour, respectively, and further the total amount of the fats and oils and the water-soluble dietary fiber is not less than 37 parts by mass and not more than 100 parts by mass.

3. The method of making a cake according to claim 1, wherein the water-soluble dietary fiber is at least one selected from the group consisting of indigestible dextrin, polydextrose, and inulin.

4. The method of making a cake according to claim 2, wherein the water-soluble dietary fiber is at least one selected from the group consisting of indigestible dextrin, polydextrose, and inulin.

5. The method of making a cake according to claim 1, wherein the cake is selected from the group consisting of a sponge cake, butter cake, muffin, cupcake, financier, madeleine, pound cake, and waffle.

6. The method of making a cake according to claim 2, wherein the cake is selected from the group consisting of a sponge cake, butter cake, muffin, cupcake, financier, madeleine, pound cake, and waffle.

7. The method of making a cake according to claim 3, wherein the cake is selected from the group consisting of a sponge cake, butter cake, muffin, cupcake, financier, madeleine, pound cake, and waffle.

8. The method of making a cake according to claim 4, wherein the cake is selected from the group consisting of a sponge cake, butter cake, muffin, cupcake, financier, madeleine, pound cake, and waffle.

9. A cake made by the method according to claim 1.
